(19) United States
(12) Patent Application Publication
(10) Pub. No.: US 2005/0219951 A1
(43) Pub. Date: Oct. 6, 2005

(54) Finding underground animals using transducer probes

(76) Inventor: Charles A. Walton, Los Gatos, CA (US)

Correspondence Address: Charles A. Walton, 19115 Overlook Road, Los Gatos, CA, 95030, US

(21) Appl. No.: 10/816,316

(22) Filed: Apr. 2, 2004

(51) Int. Cl. A01M 1/00; H04B 1/06

(52) U.S. Cl. 367/139

(57) ABSTRACT

Animals which make their home in burrows or underground are detected by multiple probes driven into the ground. The tips of the probes include thermocouples. The thermocouple readings are displayed by digital or other means. The animal body temperature causes the earth to be warmer nearer to the animal burrow or nest. The temperature differences form a temperature gradient, with the warmest part being nearest to the burrow. The gradient is followed and used to locate the burrow. Extermination is then used on the animals. The animals are typically gophers. Alternatively, the probes are equipped with microphones, so that burrow sounds are detected, and the burrows are located according to the strength of the sound. Alternative to driving probes in to the ground, there is a self propelled probe bearing a video camera, and temperature and sound sensors, allowing the probe to be guided by ah operator to the home nest.

### SUMMARY OF INVENTION

Gophers are a stubborn form of pest. They leave earth mounds at the surface scattered through an infested area. They eat the roots of desirable plants. Other attempts at removal are ineffective. They avoid poison. They retreat from smoke and return. They avoid flooding by temporary retreat to other burrows. Traps only catch a minority of the population, while the remainder continue to dig.

In this system, their body temperature is sensed to allow the finding of the breeding nests. Animals which make their home in burrows or underground are detected by multiple probes driven into the ground. The tips of the probes include thermocouples. The thermocouple readings are displayed by digital or other means. The animal body temperature causes the earth to be warmer nearer to the animal burrow or nest. The temperature differences form a temperature gradient, with the warmest part being nearest to the burrow. The gradient is followed and used to locate the nest or central portion of gopher living.

Permanent or long term eradication is then possible. Alternative to temperature is their sound. Multiple probes read a temperature or sound which leads to the nest. A more sophisticated procedure is to use a single probe, which is motorized and guided by an operator, or self guided automatically, to the nest. The motorized version usually operates at the end of cable or umbilicus.

### BRIEF DESCRIPTION OF FIGURES

FIG. 1. Thermocouples Probing Underground Temperature

FIG. 2. An Individual Probe

FIG. 3. Microphones Probing Underground Sound

FIG. 4. A Motorized Probe System with Video, Temperature, and Sound Reporting for Burrow Tracing

### DETAILED DESCRIPTION

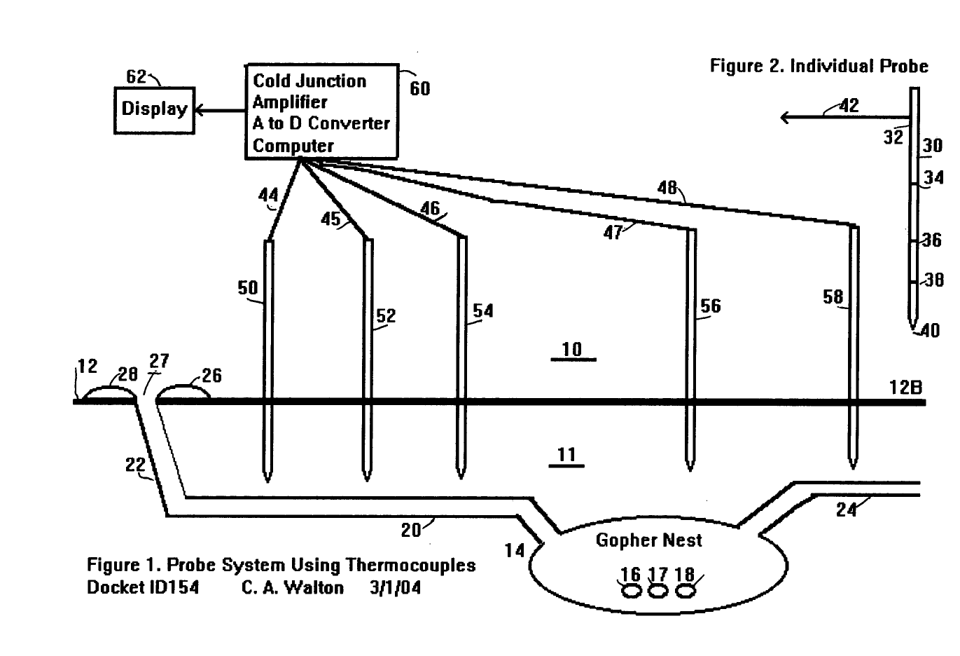

FIG. 1 shows the primary system 10. There is an ample supply of ground 11, with a surface 12 and 12B. All above 12 is the normal atmosphere. Within ground 11 there may be animal pests, such as gophers, or similar warm blooded animals. The gopher nest 14 contains gopher animals 16, 17, and 18. These animals 16 etc., communicate with the surface 12 through burrows 20, 22, and 24. Burrow 24 exits through the surface 12 to the right side of FIG. 1. The dirt removed from the burrows by the gophers 16 is deposited around the exit holes 27 in piles 26 and 28. There are probes 50, 52, 54, 56, and 58.

An example probe 30 is shown in FIG. 2. Probe 30 carries at its tip a sensor 40, such as a thermocouple or a microphone, able respectively to detect temperature and sound. The probe 30 is driven into the ground in the suspected neighborhood of gopher nest 14. The probe 30 bears identification marks 32, 34, 36, and 38, etc., which also may have differing colors, allowing the operator to readily determine the depth to which the stake has been driven. In use generally multiple probes 30 are all driven to the same depth, so that temperature variations owing to depth is neutralized. The wires 42 from the transducer exit near to, but not at, the upper point of the probe. The upper end is hard material able to withstand multiple blows from the hammer used to drive in the probe 30.

The probe 30 also serves later as a conduit for introducing poison into the burrow or nest of the gophers.

Return to FIG. 1. The system uses multiple sensing probes 30 numbered 50, 52, 54, and 56. Each of the probes bears a transducer 40 at its tip. The wires for the transducer are brought from the probes over conductors 44, 45, 46, 47, 48 to junction points in the central unit box 60. The transducer signals are amplified. Within box 60 there are amplifiers and there are the cold junctions necessary for functioning of the thermocouples, and usually an analog to digital converter. The ADC sends the readings to a computer. The computer feeds the data to a display 62, which is usually a digital display of all the thermocouple readings.

To operate the system, the operator implants several probes, typically three, although it could be done with more or even a single probe, used repetitively. The subground level temperatures are read. These readings will all be the same, except in the vicinty of heat sources, and except that in the vicinity of the gopher nest the readings will be higher. The operator then reinserts one of the more coolest reading thermocouple probe 30 into another location, in the direction of the highest temperature. This process is continued until a peak reading is found.

The peak reading will occur above or lateral to the gopher nest. At this point an entry is made into the nest, using an even longer probe or equivalent, and poisonous gas or liquid is injected into the nest, thus extinguishing the gopher family for some time.

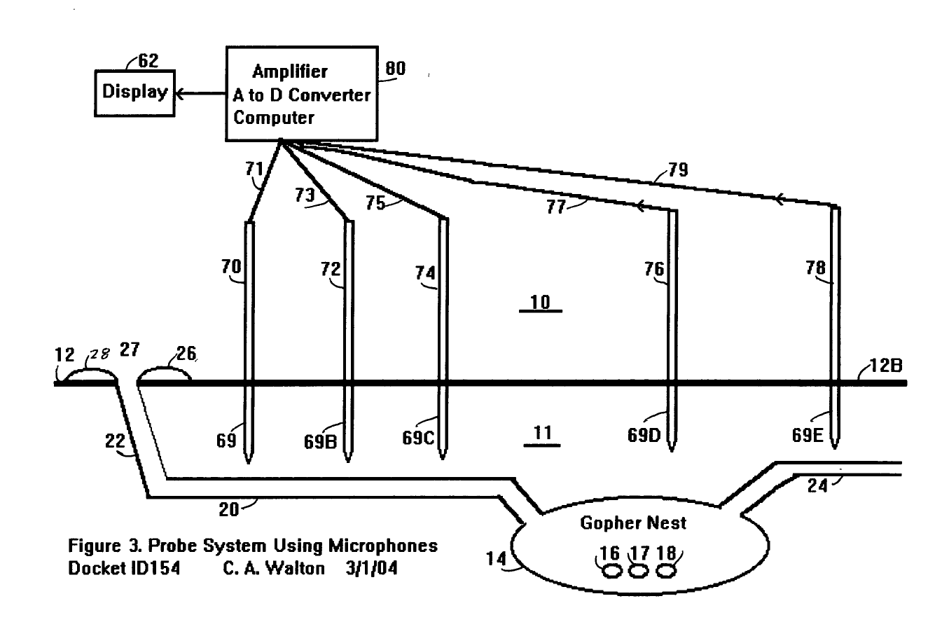

FIG. 3 shows an alternative system. Rather than thermocouple 40, a microphone 69 is used, in probe 70. An identical microphone 69B is used in probe 72, microphone 69C in probe 74, etc. The operator listens to the sounds from the burrow and measures the amplitude. The probes are reinserted in the direction of increased signal strength or amplitude, as is done for the thermocouple type probe, until the point of maximum activity and maximum sound is reached. The loudest sound marks the burrow location, now vulnerable to extermination of the population of the nest.

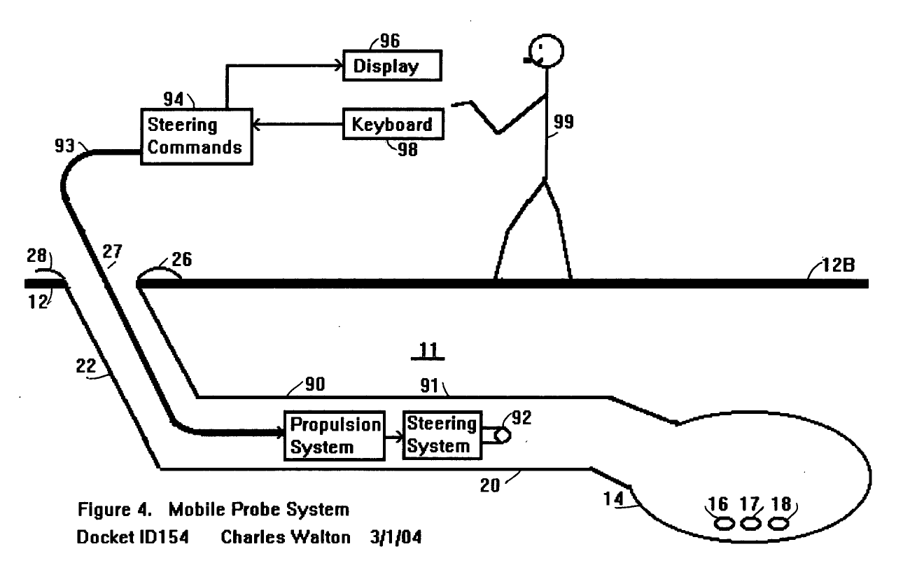

In FIG. 4 the probe is mobile and self propelled. It is inserted into the opening 27 at the center of mounds 26 and 28. It passes through tunnels 22 and 20. There is a two way motorized propulsion system 90. Propulsion may be by counter-rotating worm screws, or wheels on the motorized system which drive against the tunnel walls 20. There is a Steering system 91 which leads the propulsion system 90. In front are sensing devices 92 incorporating a video camera, and which may also include temperature sensing and sound sensing. The motorized system is powered and commanded through cable 93. Commands are generated and power is supplied to 90 through command unit 94. Cable 93 also brings back intelligence from the sensors 92. The information is placed in Display Unit 96. The operator 99 is able to respond with instructions through keyboard 98.

In operation the Mobile Probe System is steered down the gopher tunnel until a nest is found. The information is reported and elimination of the burrow can proceed. The Mobile System may also carry a canister of poison to do the elimination. The principles are somewhat similar to that of colonoscopy in the human body.

A comparable technique is that applied to the study of the brains of human beings. Multiple electrodes or surface probes allow the finding of sources of heat generation within the skull. These sources show what parts of the brain are consuming oxygen in the process of various categories of thinking. The programs used for brain locations can also do the programs for multiple probes for heat sources within the earth.

Variations and Problems:

1. The system will also find yellow jackets, wasps, carpenter bees, squirrels, cockroaches, prairie dogs, people, etc. The probes might be inserted into trees to locate animals.
2. The temperature variations in the ground are also detectable at or near the surface. Infra-red binoculars can thus detect variations. At the longer heat wavelengths, there can be detection below the ground surface. Random surface variations obscure the surface temperature variation owing to animal presence. Wind blowing over the surface, in some places at differing speeds, partly obscure the temperature variations due to burrows.
3. Use radioactive smoke. The smoke is driven into the burrows and tracked from above with radio activity detectors.
4. Since the gopher nest is typically several feet down, and scattered through the land, a search grid of every 10 or 20 feet is recommended. Probes are spaced every several feet, several feet down, in a Cartesian grid, initially on the order of ten feet by ten feet.
5. The sensors may be integral with the probes, or may be slid into the probe after the probes have been driven into the ground. Use thermometers intended for body temperature medical purposes.
6. The system is good for locating animals or people, and the search may stop after location, without an extermination step.

1. A system using probes to locate hidden animals in the ground, in which said probes carry within or attached thereto transducers, capable of converting a physical effect to an electrical signal.

2. A system using probes as in claim 1 using transducer probes to locate hidden animals, in which said transducers may be thermocouples, for measuring temperature, or microphones for detecting sounds.

3. A system using probes as in claim 1 in which said probes are in the form of stakes capable of being driven into the ground in the neighborhood of suspected dwellings of hidden animals.

4. A system as in claim 1 using probes which incorporate transducers to locate hidden animals, in which said animals are gophers, moles, rabbits, or other animals who typically create nests in the ground.

5. A system as in claim 2 in which temperature or sound level is displayed in digital form, for human readable numbers, or for number entry into a computer, or where display is the motion of a needle.

6. A system as in claim 1 in which said electrical signals from neighboring probes are compared to determine the direction of the hidden animals, and in which the greater temperature reading difference between two or more probes represents the direction of the location of the hidden animal, so that location of the home burrow can be determined.

7. A system as in claim 1 to locate hidden animals in which said probe said probe is mobile and able to follow know animal tunnels, and is able to follow these tunnels to the central nest.

8. A system as in claim 7 in 20 in which aid probe is propelled by an integral power propulsion system, and is able to push against the walls of said tunnel and move ahead, carrying behind it a lengthy cable delivering power to the driving system, said wire also bearing intelligence for forward steering, and intelligence findings back to a central station.

9. A system as in claim 8 in which said mobile probe also carries a video camera, able to send a picture backwards of the situation within the tunnel, and report animals or rescue people in the tunnel.

10. A system as in claim 1 in which the search is not in the ground but in a tree or structure

11. A method for locating hidden animals, in which probes sense a characteristic of said animals, and report to external equipment the magnitude of those characteristics.

12. A method as in clam 11 in which successive probes are driven, with the point of the probe insertion moving in the direction of increased signal strength from said characteristics.

13. A method as in claim 11 in which an operator successively drives probes placed in the direction of increasing temperature or increasing animal sound, until a peak or maximum is reached, indicating the location of a burrow or home nest.

14. A method as in claim 11, in which once said burrow or nest is located a poison can be inserted into or near the said maximum, and said nest, to eliminate the family of said animals.
